(19) United States
(12) Patent Application Publication
(10) Pub. No.: US 2005/0260365 A1
(43) Pub. Date: Nov. 24, 2005

(54) Wound tubes with partially adhered structural layers, and methods for making same

(75) Inventors: Xiaokai Niu, Hartsville, SC (US); John Whitehead, Hartsville, CA (US); Wim van de Camp, Hartsville, SC (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Sonoco Development, Inc.

(21) Appl. No.: 10/976,985

(22) Filed: Oct. 29, 2004

Related U.S. Application Data
(63) Continuation-in-part of application No. 10/850,138, filed on May 20, 2004.

(51) Int. Cl. B32B 1/08; B65H 81/00

(52) U.S. Cl. 428/34.1; 428/36.9; 156/190; 156/291

(57) ABSTRACT

In a wound paperboard tube, adhesive is applied between two or more structural paperboard layers in a partial-coverage pattern characterized by spaced regions of adhesive interspersed with adhesive-free portions of the facing surfaces of the layers. The pattern can comprise islands of adhesive spaced apart in both circumferential and longitudinal directions of the tube, or intersecting lines of adhesive spaced apart in both circumferential and longitudinal directions and forming a grid, or the like. The tubes can be spirally wound, convolutely wound, or formed by a linear draw process. Tube strength is not substantially compromised by reducing adhesive coverage substantially below 100%, on a surface area basis.

### CROSS-REFERENCE TO RELATED APPLICATION

This application is a continuation-in-part of U.S. patent application Ser. No. 10/850,138 filed May 20, 2004, currently pending, the entire disclosure of which is incorporated herein by reference.

### BACKGROUND OF THE INVENTION

The present invention relates to tubes formed by winding paperboard sheet material about an axis and adhering overlying layers together with adhesive. The invention in preferred embodiments relates more particularly to such tubes designed for use as winding cores, corner posts, construction forms, and container bodies, where substantial strength is demanded from the structural paperboard layers of the tube.

Wound paperboard tubes are used in a variety of applications where considerable strength is required. For instance, paperboard winding cores are used for winding rolls of paper mill sheet, where the rolls can be up to several meters in length and can weigh up to several tons. Paperboard winding cores are also used for winding other sheet materials such as metal sheet or foil, plastic film, textiles, and the like. The strength demands of winding cores can be quite substantial, as a core must have sufficient bending stiffness to support the weight of a full roll when the core is supported only at its ends, and must have adequate flat crush strength, radial crush strength, and ID stiffness to withstand the substantial radially inward pressure exerted by the material wound about the core without failing or substantially deforming. In other applications, different strength properties may be of greater importance. For instance, container bodies need substantial flat crush resistance, but often also need axial column strength to withstand the weight of other containers stacked atop them. Construction forms such as forms for poured concrete columns have yet different requirements in terms of strength.

Considerable effort has been expended in designing wound paperboard tubes to enhance or optimize certain key strength properties depending on the particular intended usage, such as axial column strength (see U.S. Pat. No. 6,309,717, incorporated herein by reference), flat crush strength (see U.S. Pat. No. 5,393,582, incorporated herein by reference), ID stiffness (i.e., resistance to reduction in inside diameter caused by radially inward compression from the wound material, see U.S. Pat. No. 5,505,395, incorporated herein by reference), resistance to explosion at high winding speeds (particularly relevant to yarn tubes for winding yarn, see U.S. Pat. No. 5,472,154, incorporated herein by reference), and other properties.

The vast majority of paperboard tubes currently being produced worldwide are manufactured with the use of aqueous adhesives, examples of which include vinyl acetate/ethylene copolymers, polyvinyl alcohol, polyvinyl acetate (a.k.a. “white glue”), dextrine, casein, and acrylics. Aqueous adhesives are favored principally because they are relatively inexpensive, are environmentally friendly in comparison with solvent-based adhesives, and are easy to apply and to clean up. A known drawback of aqueous adhesives, however, is that moisture from the adhesive is absorbed by the paperboard (a phenomenon often termed “moisture add-on”). A completed tube generally must be stored for a substantial period of time to allow the excess moisture from the adhesive to evaporate, before the tube reaches its full strength potential. It is also known that paperboard tends to exhibit a hysteresis effect with respect to its moisture content, such that two identical specimens of paperboard that initially have different moisture content will retain some difference in moisture content even when allowed to reach equilibrium in the same environment. Thus, it has long been known that moisture add-on is undesirable in the manufacture of paperboard tubes. However, the advantages of aqueous adhesives are such that in most cases they are still used, despite the inevitable moisture add-on that results.

In paperboard tube applications requiring substantial strength, it has generally been assumed that the “structural” paperboard layers (defined herein as those layers whose predominant function in a wound tube is to provide one or more structural strength properties to the tube, as opposed to being used predominantly for their non-structural characteristics such as appearance, surface finish or coefficient of friction, moisture and/or gas barrier performance, etc.) must be bonded together over their entire surfaces in order to optimize the strength properties of the tube. Given this assumption, and given the desirability of using aqueous adhesives, it has been difficult to satisfactorily address the moisture add-on problem.

Work has been done to mitigate or altogether avoid the moisture add-on problem. One approach, for example, has been to switch to a non-aqueous adhesive such as a hot melt, or a water-based high-solids (e.g., >60% solids) adhesive. Such adhesives are expensive and difficult to use because of their high viscosity. Another approach has been to use aqueous adhesive, but to reduce the amount of the adhesive used. For instance, U.S. Pat. No. 6,296,600 to Drummond et al., incorporated herein by reference, discloses a method of reducing the migration of water into the paperboard by using a foamed adhesive, which reduces the amount of adhesive that comes into contact with the paperboard. Drummond teaches that the foamed adhesive is applied over the entire surfaces of the plies.

### BRIEF SUMMARY OF THE INVENTION

The present invention represents a development that runs contrary to the above-noted assumptions and conventional way of thinking about paperboard tube design. Through development testing whose results were quite unexpected, it has been found that key paperboard tube strength properties are not substantially compromised when the adhesive is applied to the structural paperboard layers in a partial-coverage pattern characterized by spaced regions of adhesive interspersed with adhesive-free portions of the facing surfaces of the layers. The partial-coverage pattern can be from about 15% to about 90% on a surface area basis. The pattern can comprise islands of adhesive spaced apart in both circumferential and longitudinal directions of the tube, or intersecting lines of adhesive spaced apart in both circumferential and longitudinal directions and forming a grid, or the like. The layers adhered by the partial-coverage pattern are in substantially full surface contact with each other, as distinguished from a single- or double-faced corrugated board, for example, wherein the adhesive only partially covers the corrugated sheet and non-corrugated face sheet(s) but the adjacent sheets are not in substantially full surface contact.

Wound tubes in accordance with the invention can be formed by various manufacturing processes, including spiral or helical winding, convolute winding, or linear draw formation. The tubes in some embodiments comprise winding cores having at least three structural paperboard layers, up to as many as 30 or even more layers. Other embodiments comprise composite can bodies having two or more structural layers. In preferred embodiments, all of the structural layers are adhered with partial-coverage adhesive patterns.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a diagrammatic depiction of an apparatus and process for making a wound tube in accordance with one embodiment of the invention;

FIG. 2 is a perspective view of the tube formed by the process of FIG. 1, with a portion of the two outermost plies peeled back to show the partial-coverage adhesive pattern;

FIG. 3 is a top elevation of a ply having an alternative partial-coverage adhesive pattern in accordance with the invention, comprising intersecting lines of adhesive forming a grid;

FIG. 4 is a schematic end elevation of one embodiment of an adhesive applicator for applying a partial-coverage adhesive pattern in accordance with the invention;

FIG. 5 is a perspective view schematically depicting a linear draw apparatus and process for making a wound tube in accordance with a further embodiment of the invention;

FIG. 6 is an elevation of a convolutely wound tube in accordance with a further embodiment of the invention, in the process of being wound;

FIG. 7 is a bar graph showing results of flat crush tests conducted on a number of convolutely wound tubes made with dextrine adhesive in accordance with the invention as well as control tubes having 100% adhesive coverage; and

FIG. 8 is a bar graph similar to FIG. 7, showing flat crush test results for tubes made with PVOH adhesive.

### DETAILED DESCRIPTION OF THE INVENTION

The present inventions now will be described more fully hereinafter with reference to the accompanying drawings, in which some but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

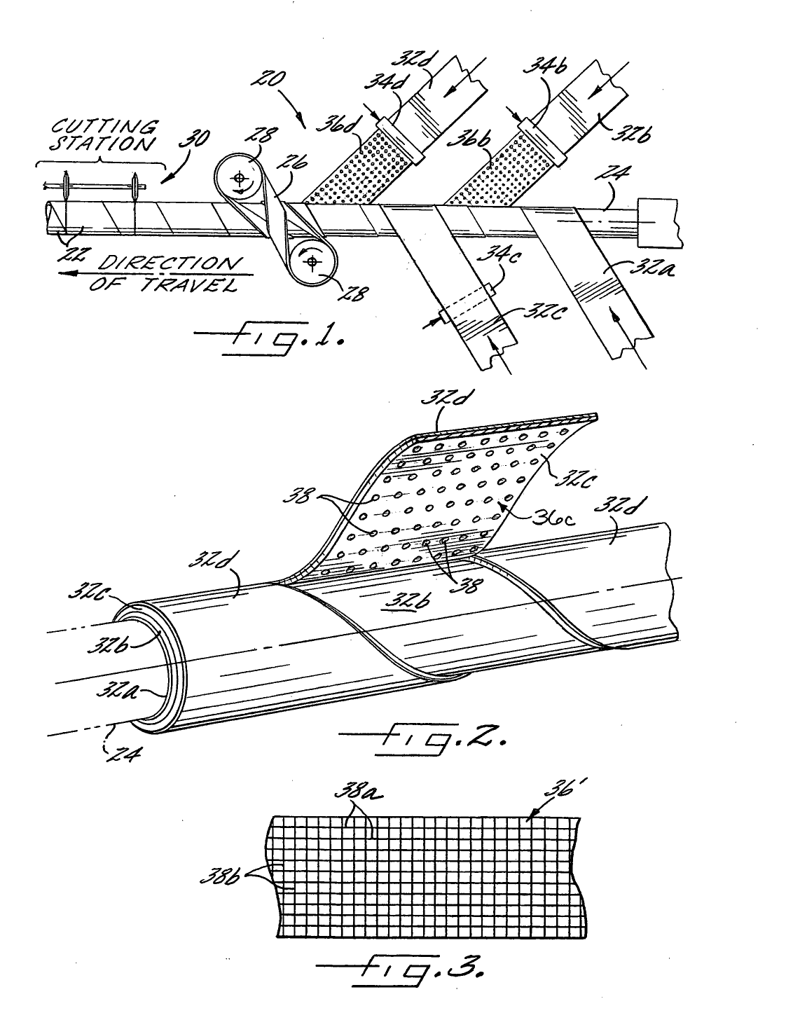

With reference to FIG. 1, an apparatus 20 and a process for making wound tubes in accordance with one embodiment of the invention are illustrated. The apparatus 20 is a spiral winding apparatus for making spirally or helically wound tubes 22, one of which is depicted in greater detail in FIG. 2. The apparatus and process of FIG. 1 illustrate the manufacture of a 4-ply tube, but the principles pertaining to the 4-ply tube are equally applicable to tubes having any number of plies. The apparatus includes a cylindrical mandrel 24 whose diameter is selected to match the desired inside diameter of the tubes to be manufactured, a winding belt 26 arranged to wrap about the tube formed on the mandrel and about a pair of rotating drums 28 that drive the belt such that the belt advances the tube along the mandrel in screw fashion at a substantially constant pitch, and a cutting station 30 operable to cut the continuous tube formed on the mandrel into individual tubes 22.

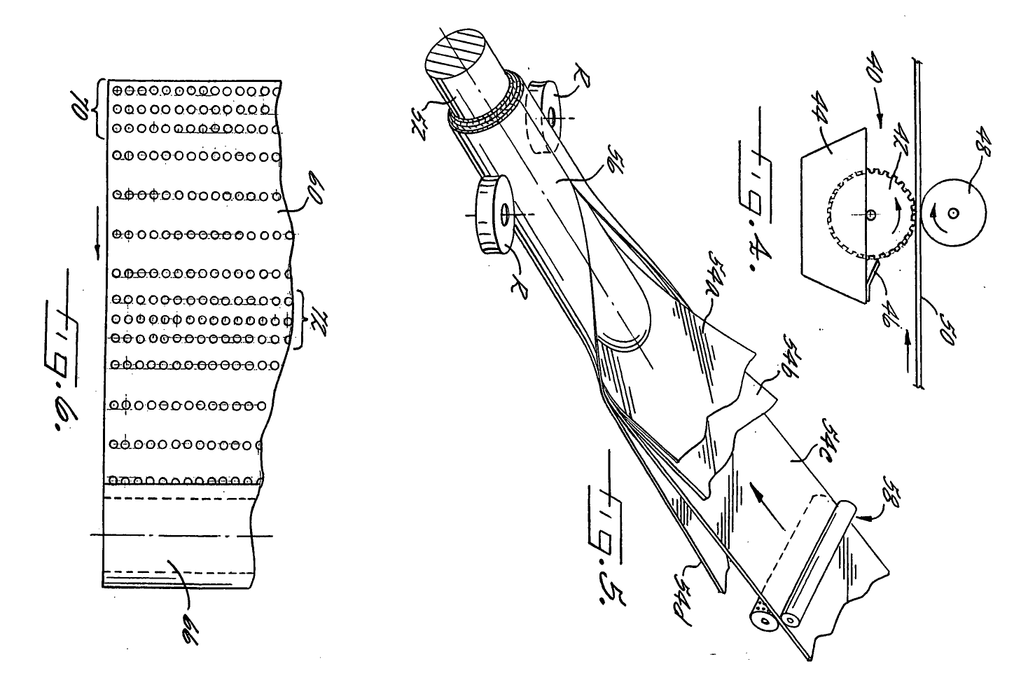

Four plies 32a, 32b, 32c, and 32d are drawn from respective supply rolls (not shown) and are advanced toward the mandrel 24 and are sequentially wrapped about the mandrel in radially superposed fashion, one atop another. The apparatus includes adhesive applicators 34b, 34c, and 34d for applying adhesive to each of plies 32b, 32c, and 32d, respectively. The adhesive applicators are structured and arranged so as to apply the adhesive to each of plies 32b, 32c, and 32d in a partial-coverage pattern 36b, 36c, and 36d, respectively. Each of the partial-coverage adhesive patterns is characterized by spaced regions of adhesive, which can comprise islands or dots as shown in FIG. 1, or alternatively can comprise lines (continuous or broken) of adhesive that intersect and form a grid (FIG. 3). In any event, there are regions of adhesive that are interspersed with or separated by substantially adhesive-free portions of the surface of the ply. Preferably, the adhesive regions are spaced apart in both length and width directions of the ply. The adhesive pattern 36b adheres the innermost ply 32a to the next ply 32b by bonding to the respective facing surfaces of those plies. Likewise, plies 32b and 32c are adhered together by the adhesive pattern 36c, and plies 32c and 32d are adhered together by the adhesive pattern 36d. The adhesive patterns are shown as being applied to the radially inwardly facing surfaces of plies 32b-d, but alternatively the adhesive patterns could be applied to the outwardly facing surfaces of plies 32a-c, as will be understood by those skilled in the art.

FIG. 2 shows a resulting tube 22 formed by the apparatus and process of FIG. 1. Portions of the two outer plies 32c and 32d are peeled back for illustrative purposes, to show the partial-coverage adhesive pattern 36c on the inwardly facing surface of the ply 32c. As illustrated in FIG. 2, the two centrally located or “intermediate” plies 32b and 32c are thicker than the innermost ply 32a and outermost ply 32d. The intermediate plies thus are intended to represent plies whose predominant function or purpose is to provide structural strength to the tube 22; hence, plies such as these are termed “structural” plies herein. In contrast, as noted, plies 32a and 32d are considerably thinner and therefore not as strong as the intermediate plies. In some cases, relatively thin plies such as 32a and 32d, particularly when they are the innermost and/or outermost ply or plies, may be selected primarily for purposes other than providing structural strength to the tube. For example, an outermost ply such as the ply 32d may be selected primarily for its appearance, its surface finish (e.g., very smooth for low coefficient of friction), its moisture and/or gas barrier properties, or other reasons. An innermost ply such as the ply 32a similarly may be selected mainly for reasons other than structural strength.

In other cases, one or more plies of a tube may be selected primarily for strength and would constitute structural plies as that term is used herein, regardless of whether one or more of the plies may also have one or more other desirable properties unrelated to strength. Tubes in accordance with the invention can have all structural plies, or some structural and some non-structural plies. In some embodiments of the invention, there are two or more structural plies, such as in the tube 22. In other embodiments, there are at least three structural plies The adhesive pattern 36c shown in FIG. 2 is formed by spaced dots or islands 38 of adhesive. The islands are spaced apart in both the width and length directions of the ply 32c to which they are applied. The dots are shown as being generally circular, but dots of any shape could be used. Indeed, the invention is not limited to partial-coverage adhesive patterns of any particular configuration. Thus, spaced dots or islands can be used as in FIG. 2. Alternatively, a grid-like pattern 36′ can be used as shown in FIG. 3. The grid pattern is formed by a first series of spaced lines 38a that extend in a first direction (in this example, the length direction of the ply) and a second series of spaced lines 38b that extend in a second direction (in this example, the width direction). Thus, there are adhesive regions (lines 38a) that are spaced apart in the width direction, and other adhesive regions (lines 38b) that are spaced apart in the length direction. Still other patterns could be used, such as combinations of lines and dots, curved or wavy lines, zigzagged lines, and others.

Various types of adhesive applicators can be used in the practice of the invention. FIG. 4 shows a gravure type of applicator 40, comprising a cylindrical gravure roll 42 whose outer surface is machined, etched, or otherwise formed to include recessed regions for holding adhesive. A lower portion of the roll is submerged in a reservoir 44 containing liquid adhesive, and as the roll rotates about its axis, the outer surface of the roll picks up adhesive, which fills the recesses and also covers the non-recessed areas of the surface. A doctor blade 46 scrapes the outer surface of the roll to remove the adhesive from the non-recessed areas, such that adhesive remains substantially only in the recesses. The gravure roll forms a nip with a back-up or impression roll 48, and a ply 50 is passed through the nip. As the ply passes through the nip, the gravure roll contacts the ply surface and the adhesive in the recesses of the roll is transferred onto the ply surface. The recesses in the gravure roll can be configured in any manner, depending on the desired adhesive pattern to be applied. Other types of adhesive applicators can be used, such as rotary screen type devices, pattern spray devices, etc.

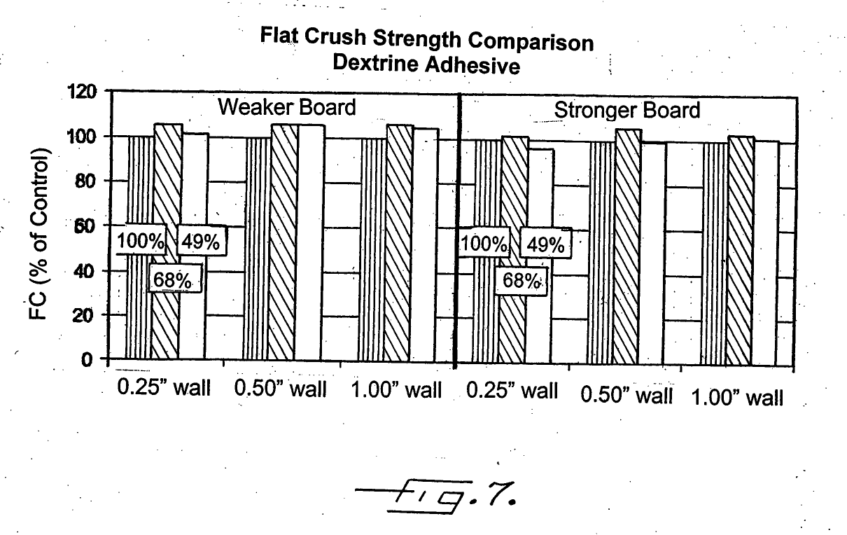

The invention is not limited to tubes formed by the spiral winding process. For instance, FIG. 5 illustrates a linear draw forming process in accordance with the invention. A cylindrical mandrel 52 is provided having a diameter matching the desired inside diameter of a tube to be formed. Two or more plies, and in this case four plies 54a, 54b, 54c, 54d, are advanced linearly toward the mandrel such that they approach the mandrel in a direction substantially parallel to the mandrel axis. The plies 54a, 54b, 54c, 54d can all be structural plies, or one or two of them can be non-structural. Forming devices (not shown) such as plows or the like are used to wrap each ply into a generally tubular shape around the mandrel so that the width of each ply extends about the circumference of the mandrel. The ply width is selected to be equal to or slightly greater than the mandrel circumference so that the opposite longitudinal edges of each ply form a butt joint or slightly overlap. Although not so illustrated in FIG. 5, preferably the plies are circumferentially staggered relative to one another so that the edges of one ply are not circumferentially aligned with those of an adjacent ply. Adhesive is applied to the plies to adhere the plies together. The tube 56 thus formed on the mandrel is advanced linearly along the mandrel by suitable devices such as friction rollers R or the like. In accordance with the invention, at least two structural plies of the tube are adhered together with a partial-coverage adhesive pattern applied by a suitable adhesive applicator, such as the gravure type applicator 58 shown in the drawing. The applicator 58 applies a partial-coverage adhesive pattern to the surface of ply 54c that faces ply 54d. Although not illustrated, partial-coverage adhesive applicators can also be used for applying adhesive to one or more of the other plies.

The invention is also applicable to convolutely wound tubes. FIG. 6 shows a simplified schematic illustration of a convolute winding process. A single sheet 60 of paperboard having opposite longitudinal edges is convolutely wound for a plurality of turns about an axis that is parallel to the longitudinal edges of the sheet so that the sheet forms a tube 66 having a plurality of layers defined by the sequential turns of the sheet.

Adhesive is applied in a partial-coverage pattern to one surface of the sheet using a suitable applicator (not shown) such as the previously illustrated gravure type applicator.

Since the sheet is wound about a mandrel (not shown), it is necessary to refrain from applying adhesive to the part of the sheet that contacts the mandrel (i.e., the first full wrap about the mandrel), so that the sheet does not adhere to the mandrel.

Tubes in accordance with the invention can have partial-coverage adhesive patterns that are either uniform or non-uniform in terms of the percentage of a unit area of the ply surface that is covered by adhesive. Where a non-uniform pattern is employed, the pattern can be substantially uniform in one direction while being non-uniform in another direction (e.g., multiple spaced rows of dots can have uniform spacing of dots in each row while the rows are spaced apart with non-uniform spacing, or the rows can be uniformly spaced while the dots in each row are non-uniformly spaced, etc.), or the pattern can be non-uniform in more than one direction. In the case of tubes formed by linear draw or convolute winding processes, a partial-coverage adhesive pattern can be applied to one or more plies in such a manner that a partial-width portion of the sheet (where “width” is here defined as the direction of the ply that extends circumferentially about the tube) extending parallel to the axis has a relatively greater adhesive coverage per unit area than other partial-width portions of the sheet.

For instance, FIG. 6 depicts the adhesive pattern as having a relatively greater adhesive coverage in partial-width portions 70 and 72 compared with other partial-width portions of the sheet 60. The partial-width portion 70 is adjacent the edge of the sheet that will be at the outer diameter of the wound tube; a similar partial-width portion of greater adhesive coverage can be provided on a region of the sheet that will contact the opposite edge of the sheet as well. The greater adhesive coverage contacting the edges of the sheet can help ensure that the edges remain firmly bonded to the adjacent layers of the tube. It may also be beneficial to have greater adhesive coverage in one or more partial-width portions not adjacent to an edge of the sheet, such as the area 72. If two partial-width portions of greater adhesive coverage are spaced apart by approximately the circumference of the tube, then they will be circumferentially aligned with each other when the sheet is wound into a tube. This can be advantageous for reinforcing a partial-circumference portion of the tube. For example, in the case of a corner post that is initially formed as a circular tube and then deformed before the adhesive sets into a non-circular shape, the tube can be formed with greater adhesive coverage in those areas that have tight bends with a small radius of curvature, while lesser adhesive coverage can be used in areas of more gentle bends with larger radius of curvature.

To test the effects of partial adhesive coverage on tube strength, a series of convolutely wound tubes were manufactured having various percentages of adhesive coverage between the plies, and a flat crush test was performed on the tubes. A first set of tubes was constructed from 0.025 inch (0.635 mm) caliper paperboard of a first grade, using an aqueous dextrine adhesive. The tubes were made in three configurations all having the same inside diameter of 5.6 inches (142 mm) but different wall thicknesses of 0.25 inch (6.35 mm), 0.50 inch (12.7 mm), and 1.00 inch (25.4 mm). For each wall thickness, tubes were made with three different adhesive coverage percentages: 100%, 68%, and 49%. All of the adhesive patterns were applied using a rotary screen type of applicator device. A specially prepared screen was used for each coverage percentage, to apply partial-coverage adhesive patterns of grids generally as described above and shown in FIG. 3. The 100% coverage was achieved with a “blank” screen (i.e., a screen having all holes unblocked) that applied adhesive dots so close together that the dots flowed together into a continuous layer of adhesive so that 100% of the surface area was covered with the adhesive. The 68% and 49% coverages were achieved with screens having respectively about 25% and 50% of the holes chemically blocked in a repeating square pattern such that the dots of adhesive merged into lines on the paperboard in a grid pattern generally as shown in FIG. 3. The preparation of screens in this fashion is well known in the screen printing field, and hence is not further described herein. There were adhesive-free regions of the surface between the grid lines. This was verified by soaking sample tubes in water and unwinding the paperboard, whereupon the grid lines of adhesive were still visible on the paperboard for the 68% and 49% patterns.

A second set of tubes were constructed in the same ID and wall thickness configurations as the first set, using the same dextrine adhesive and the same three adhesive coverage percentages, except that a higher (stronger) grade of paperboard was used.

Multiple samples of tubes of each configuration were subjected to a flat crush test. In accordance with the test procedure employed, all tubes were fully conditioned before testing at a consistent relative humidity and temperature for a period of time sufficient for the moisture content of the tubes to reach equilibrium. The tubes were placed between two flat platens and compressed along their sides as one of the two flat platens moved at a constant rate. The load was continuously recorded. The reported flat crush strength was the maximum load obtained during the test. The flat crush strength values were averaged for all samples of a given configuration. For all configurations having partial-coverage adhesive patterns, the average flat crush strength was then normalized as a percentage of the flat crush strength of the “control” tube having 100% adhesive coverage.

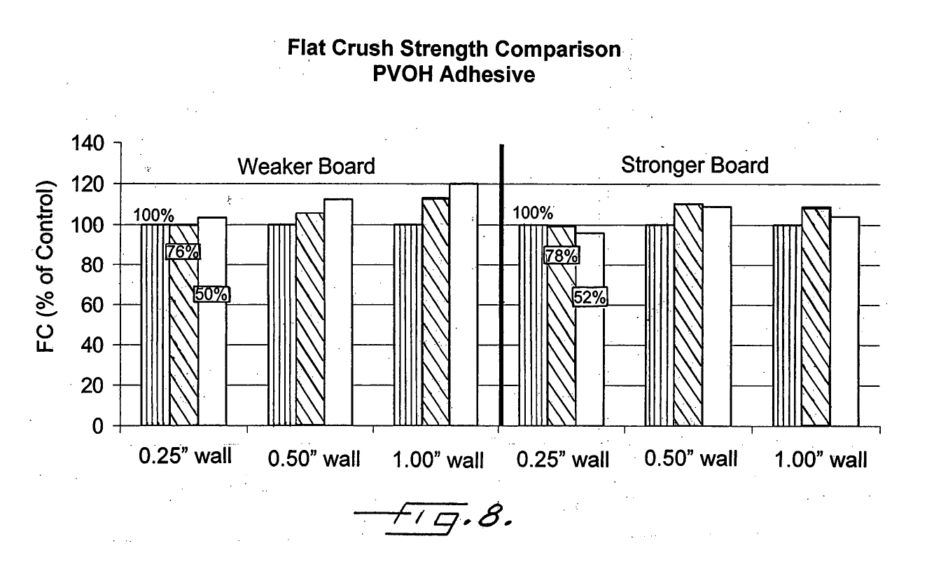

FIG. 7 shows the results of the tests as described above. Surprisingly, the test results indicate that for all tube configurations, the flat crush strength is not particularly sensitive to the percentage of adhesive coverage. For the tubes manufactured with the relatively lower paperboard grade, the flat crush strength with partial-coverage adhesive patterns actually improved slightly relative to the control tubes having 100% adhesive coverage. Similar results were obtained with the tubes made from the higher-grade paperboard (with the exception that the 0.25-inch wall tubes at 49% adhesive coverage achieved a flat crush strength several percent lower than the control). This was unexpected and is not completely understood. However, although the applicants do not wish to be bound by theory, one thought is that the reduced moisture add-on with partial-coverage adhesive patterns may be responsible for the slight improvement in flat crush strength.

Additional testing was done to assess the effect of adhesive type. A plurality of convolutely wound tubes were constructed using a rotary screen adhesive applicator, with the same dimensions as in the first series of tests, but this time a polyvinyl alcohol (PVOH) adhesive was used instead of dextrine. The tubes were made with 100%, 76-78%, and 50-52% adhesive coverages. Some tubes were made using the weaker paperboard grade, and others using the stronger paperboard grade, as in the first test. The results of flat crush testing on the tubes are shown in FIG. 8. The results are qualitatively similar to those of FIG. 7. In all cases except for the 0.25-inch wall tube made with the stronger board, the flat crush strength at 76-78% and 50-52% adhesive coverages is equal to or higher (in some cases significantly higher) than the flat crush strength for the 100%-coverage tubes.

The test results indicate that a reduction in adhesive usage in wound tube construction can be realized without substantially sacrificing flat crush strength, using partial-coverage adhesive patterns in accordance with the invention. This discovery has potential to significantly reduce the cost of tube construction while providing tubes of essentially the same mechanical properties and performance. Based on the testing described above and other testing that was done, it is believed that adhesive coverage can be in the range of about 15% to 90% with good results. Generally, in most applications it is likely that adhesive coverage of about 40% to 80% will be advantageous. However, the invention is not limited to any particular lower limit on coverage, since the usable lower limit depends in significant part on the strength requirements that apply in each case.

Many modifications and other embodiments of the inventions set forth herein will come to mind to one skilled in the art to which these inventions pertain having the benefit of the teachings presented in the foregoing descriptions and the associated drawings. For example, although not shown in the drawings, single-ply wound tubes, wherein a single ply is wrapped into a tubular shape and opposite edges of the ply are overlapped and adhesively joined together, can also benefit from the partial-coverage adhesive patterns in accordance with the invention, and the invention encompasses such single-ply tubes. Additionally, while the drawings illustrate some 4-layer tubes, the invention is not limited to any particular number of layers. Winding cores, for example, can have up to 30 or more plies, and such high-strength cores can benefit from the partial-coverage adhesive patterns in accordance with the invention. Indeed, the potential reduction in adhesive usage made possible by the invention is likely to be more significant when the number of plies is relatively great. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A wound tube, comprising:
a tubular wall constructed of a plurality of layers radially superposed upon one another such that an interface is defined between facing surfaces of each pair of radially adjacent layers, each interface having adhesive joining the facing surfaces, the layers including a plurality of structural layers whose predominant function is to provide structural strength to the tube, wherein at least one interface between radially adjacent structural layers is a partially adhered interface characterized by:
the facing surfaces of said adjacent structural layers being in substantially full surface contact with each other, and the adhesive being in a partial-coverage pattern formed by spaced regions of adhesive interspersed with substantially adhesive-free portions of the facing surfaces.

2. The wound tube of claim 1, wherein each structural layer has a width direction and a length direction, and the partial-coverage pattern comprises islands of adhesive spaced apart in both the width and length directions.

3. The wound tube of claim 1, wherein each structural layer has a width direction and a length direction, and the partial-coverage pattern comprises intersecting lines of adhesive spaced apart in both the width and length directions and forming a grid.

4. The wound tube of claim 1, wherein the layers include a radially outer layer, a radially inner layer, and a plurality of intermediate structural layers disposed between the outer and inner layers, and wherein the partially adhered interface is between two intermediate structural layers.

5. The wound tube of claim 1, wherein the layers are formed by a single sheet of paperboard wound convolutely for a plurality of turns about an axis of the tube.

6. The wound tube of claim 5, wherein the partial-coverage pattern of adhesive is configured such that a partial-width portion of the sheet extending parallel to the axis has a relatively greater adhesive coverage per unit area than other partial-width portions of the sheet.

7. The wound tube of claim 6, wherein the partial-width portion having the relatively greater adhesive coverage is adjacent one longitudinal edge of the sheet.

8. The wound tube of claim 5, wherein the partial-coverage pattern of adhesive is configured such that a plurality of spaced partial-width portions of the sheet extending parallel to the axis each has a relatively greater adhesive coverage per unit area than other regions of the sheet.

9. The wound tube of claim 8, wherein two of the partial-width portions having the relatively greater adhesive coverage are respectively located to contact regions of the sheet located adjacent opposite longitudinal edges of the sheet.

10. The method of claim 8, wherein the partial-width portions having the relatively greater adhesive coverage are spaced across the width of the sheet in such a manner that at least two said partial-width portions on radially adjacent layers of the tube are circumferentially aligned with each other when the sheet is wound to form the tube.

11. The wound tube of claim 1, wherein the layers are formed by a plurality of separate plies wrapped one upon another about an axis of the tube.

12. The wound tube of claim 11, wherein the plies are helically wrapped.

13. The wound tube of claim 11, wherein the plies are linearly drawn and wrapped such that longitudinal edges of the plies are parallel to the axis of the tube.

14. The wound tube of claim 13, wherein the partial-coverage pattern at said partially adhered interface is non-uniform in a circumferential direction of the tube.

15. The wound tube of claim 11, comprising at least three structural layers defining at least two interfaces therebetween, wherein a plurality of the interfaces between the structural layers comprise partially adhered interfaces.

16. The wound tube of claim 11, wherein the tubular wall has a radial thickness of at least about 2 mm, and all of the interfaces between structural layers comprise partially adhered interfaces.

17. The wound tube of claim 1, wherein the partial-coverage pattern is such that about 15% to about 90% of the facing surfaces are covered by the adhesive.

18. The wound tube of claim 1, wherein the partial-coverage pattern is such that about 40% to about 80% of the facing surfaces are covered by the adhesive.

19. A winding core, comprising:
a tubular wall constructed of at least three paperboard plies helically wound about an axis of the core and radially superposed upon one another such that an interface is defined between facing surfaces of each pair of radially adjacent plies, each interface having adhesive joining the facing surfaces, wherein at least one interface between radially adjacent paperboard plies is a partially adhered interface characterized by:
the facing surfaces of said plies being in substantially full surface contact with each other, and the adhesive being in a partial-coverage pattern formed by spaced regions of adhesive interspersed with adhesive-free portions of the facing surfaces.

20. The winding core of claim 19, wherein a plurality of the interfaces comprise partially adhered interfaces.

21. The winding core of claim 19, wherein the partial-coverage pattern comprises islands of adhesive spaced apart in both circumferential and longitudinal directions of the winding core.

22. The winding core of claim 19, wherein the partial-coverage pattern comprises intersecting lines of adhesive spaced apart in both circumferential and longitudinal directions of the winding core and forming a grid.

23. The winding core of claim 19, wherein all of the interfaces comprise partially adhered interfaces.

24. The winding core of claim 23, wherein the partial-coverage pattern is such that about 15% to about 90% of the facing surfaces are covered by the adhesive.

25. The winding core of claim 23, wherein the partial-coverage pattern is such that about 40% to about 80% of the facing surfaces are covered by the adhesive.

26. A wound tube, comprising:
a tubular wall constructed of at least one paperboard sheet wound about an axis in such a manner that at least a part of a length of the tubular wall comprises a plurality of layers radially superposed upon one another such that an interface is defined between facing surfaces of each pair of radially adjacent layers, each interface having adhesive joining the facing surfaces, wherein at least one interface between radially adjacent layers is a partially adhered interface characterized by:
the facing surfaces of said adjacent layers being in substantially full surface contact with each other, and the adhesive being in a partial-coverage pattern formed by spaced regions of adhesive interspersed with adhesive-free portions of the facing surfaces.

27. A method of making a winding core, comprising the steps of:
advancing a plurality of paperboard plies from respective supplies thereof toward a mandrel;
applying adhesive to a surface of each of a plurality of the paperboard plies;
wrapping the paperboard plies about the mandrel one atop another in such a manner that each pair of radially adjacent paperboard plies are joined together by the adhesive, so as to form a paperboard tube on the mandrel; and
removing the tube from the mandrel and allowing the adhesive to set;
wherein the adhesive is applied to at least one of the plies in a partial-coverage pattern comprising spaced regions of adhesive interspersed with adhesive-free portions of the surface.

28. The method of claim 27, wherein the partial-coverage pattern of adhesive is applied to a plurality of the plies.

29. The method of claim 28, wherein the partial-coverage pattern on each of the plurality of the plies is such that the adhesive covers about 15% to about 90% of the surface of each ply.

30. The method of claim 28, wherein the partial-coverage pattern on each of the plurality of the plies is such that the adhesive covers about 40% to about 80% of the surface of each ply.

31. A method of making a paperboard tube, comprising the steps of:
applying adhesive to a surface of a sheet of paperboard, the sheet having a width defined between opposite longitudinal edges of the sheet; and
convolutely winding the sheet for a plurality of turns about an axis that is parallel to the longitudinal edges so as to form a tube having a plurality of layers of the paperboard sheet radially superposed upon one another and adhered together by the adhesive;
wherein the applying step comprises applying the adhesive to the surface of the sheet in a partial-coverage pattern comprising spaced regions of adhesive interspersed with adhesive-free portions of the surface.

32. The method of claim 31, wherein the partial-coverage pattern of adhesive is applied such that a partial-width portion of the sheet extending parallel to the axis has a relatively greater adhesive coverage per unit area than other partial-width portions of the sheet.

33. The method of claim 32, wherein the partial-width portion having the relatively greater adhesive coverage is adjacent one longitudinal edge of the sheet.

34. The method of claim 31, wherein the partial-coverage pattern of adhesive is applied such that a plurality of spaced partial-width portions of the sheet extending parallel to the axis each has a relatively greater adhesive coverage per unit area than other regions of the sheet.

35. The method of claim 34, wherein two of the partial-width portions having the relatively greater adhesive coverage are respectively located to contact regions of the sheet located adjacent the opposite longitudinal edges of the sheet.

36. The method of claim 34, wherein the partial-width portions having the relatively greater adhesive coverage are spaced across the width of the sheet in such a manner that at least two of the partial-width portions on radially adjacent layers of the tube are circumferentially aligned with each other when the sheet is wound to form the tube.
